(19) United States
(12) Patent Application Publication
(10) Pub. No.: US 2020/0070290 A1
(43) Pub. Date: Mar. 5, 2020

(54) MACHINE TOOL

(71) Applicant: Gebr. Heller Maschinenfabrik GmbH, Nuertingen (DE)

(72) Inventors: Karl-Heinz Jenter, Beuren (DE); Juergen Walz, Frickenhausen (DE)

(21) Appl. No.: 16/552,788

(22) Filed: Aug. 27, 2019

(30) Foreign Application Priority Data
Aug. 28, 2018 (DE) 10 2018 120 936.3

(51) Int. Cl. B23Q 1/01; B23Q 7/08

(52) U.S. Cl. CPC B23Q 1/017; B23Q 7/08

(57) ABSTRACT

The machine tool according to the invention comprises a workpiece support (16) that is held so as to be pivotable about an A-axis. In doing so, the workpiece support (16) is held asymmetrically to the extent that it is connected only on one side to a rotary positioner (27). However, both sides are held on the slides (25, 26), each being connected to a linear drive (30, 34). The slide (26) without rotary drive runs only on one guide rail (24), whereas the slide (25) with the rotary positioner (27) runs on two guide rails (22, 23). In view of the Z-acceleration, the workpiece support (16) is guided symmetrically. The result is a compact and still highly robust machine concept.

### RELATED APPLICATION(S)

This application claims the benefit of German Patent Application No. 10 2018 120 936.3, filed Aug. 28, 2018, the contents of which is incorporated herein by reference as if fully rewritten herein.

### TECHNICAL FIELD

The invention relates to a machine tool, in particular a machine tool that is space-saving and still designed in a robust manner.

### BACKGROUND

In principle, machine tools for multi-axis workpiece processing have been known. For example, publication DE 10 2012 201 736 B3 discloses a universal machine tool comprising a table slide that is supported by three linear guides. The table slide comprises a workpiece receptacle that can be rotated about a vertical axis. The travel drive for the table slide is a linear motor arranged between two guide rails. The tool table is arranged so as to be laterally offset with respect to this linear motor. While two (pair) guide rails accommodate between them the linear motor, the chips channel is located between another two (pair) guide rails. The workpiece table is associated with a working spindle that is supported so as to be movable horizontally and vertically on the machine frame. Consequently, overall a four-axis machining of the workpiece is possible.

Publication DE 20 2007 013 009 U1 discloses a four-axis machine tool comprising a machine frame which holds a slide support that can be moved horizontally on two linear guides. Each of the two horizontal guides is associated with a linear drive. A workpiece holder is arranged on the slide, said workpiece holder being rotatable about a vertical axis. The workpiece support is associated with a working spindle for the accommodation of a machine tool that can be moved in vertical and horizontal directions via appropriate guides.

A pivoting motion of the workpiece about a horizontal axis is not provided in this embodiment. To accomplish this, the same publication suggests a modified embodiment of the processing machine that comprises two slides that can be moved independently of each other in linear direction, each of said slide comprising an L-shaped workpiece holder that can be rotated about a horizontal axis. The horizontally arranged limbs of the workpiece holder face each other. The slides running on both sides of the chips channel for the rotating units of the respective workpiece support comprise guide rails for the secure support of this slide so that this machine option comprises a total of four guide rails for the two workpiece supports.

In this machine, each of the workpieces is held on a one-arm support on which act strong forces in the event of a collision.

Publication DE 10 2015 119 646 A1 describes a machine tool with a workpiece support that is driven on one side but supported on two sides. The machine tool comprises a machine frame on which three guides are arranged parallel to each other. In doing so, there exists, between a first and a second linear guide, a distance that is smaller than the distance between the second and a third linear guide. The first and the second linear guides support a shared slide to which is allocated a linear drive. The slide of the third linear guide is not allocated a drive. Between the two slides there is arranged a workpiece support that is held so as to be pivotable about a horizontal pivot axis. A pivot drive for pivoting and positioning the workpiece support is arranged on the first slide bridging the two linear guides.

In this machine tool the not-driven slide is passively taken along by the workpiece support in the event of horizontal travel motions. This principle of operation has fundamentally proven itself. However, in the event of crashes, during which, due to malfunctions or programming errors, excessively strong horizontal forces act on the workpiece support, very high bearing stresses occur between the workpiece support and the pivoting unit.

It is the object of the invention to state a concept with which the machine tool becomes more robust in view of potential crashes.

### SUMMARY

This object is achieved with the machine tool as described herein.

The machine tool according to invention is designed, in particular, for the five-axis machining of workpieces. The workpiece support is held so as to be pivotable about a first—for example, horizontal-axis, in which case the workpiece, at least preferably, can be additionally rotated about an axis that is positioned at a right angle relative to the first axis of rotation. For the horizontal movement of the workpiece there are provided at least two parallel linear guides, one of which supporting a slide with a rotating unit for the workpiece support and the other supporting a slide which supports the workpiece holder so that it is freely movable about the same axis. A first linear drive is associated with the slide supporting the rotating unit. A second linear drive is associated with the other slide. The mechanical connection between the two driven slides is provided only by the workpiece support. Without this connection, both slides could be moved independently of each other along the guide rails in linear direction.

The linear adjustment movement is effected by both linear drives equally in that the two slides are moved in synchrony. As a result of this, not only vertical but also horizontal forces (acceleration and braking forces) acting on the workpiece are largely received symmetrically by both slides, so that no excessively large bending torques will occur on the two pivot bearings of the workpiece support which, together, define a horizontal axis. This simplifies the bearing design and protects the bearings even in the event of crashes.

The machine tool comprises at least two linear guides and thus at least two guide rails. However, it is possible to provide two guide arrangements, respectively, for the rotating unit supporting the slides and thus two guide rails on which the rotating unit supporting the slides can be supported so as to be movable back and forth. In this case the linear drive associated with the slide is preferably arranged between the two guide rails of the slide.

The machine tool according to the invention comprises at least one working spindle that is set up for the accommodation of a tool disposed for machining a workpiece and for the rotating drive of said tool. For changing and replacing the tool in the working spindle, it is possible to provide a tool changing device that links the machine tool with a tool magazine. Preferably, the at least one working spindle can be moved in two spatial directions relative to the workpiece support. These two spatial directions are preferably oriented at a right angle with respect to the spatial direction specified by the guide arrangements. In doing so, a genuine five-axis machining of the workpiece is possible (three linear axes, two pivot axes or axes of rotation).

Preferably, the two linear drives are designed for different maximum forces. The linear drive for the slide of the rotating unit is preferably designed stronger than the linear drive for the slide without rotating unit. Preferably, in doing so, the quotient of the maximum force of the respective linear drive and of the inert mass generated by the slide and the components supported by it is the same for both linear drives. Consequently, the maximum accelerations of the two slides are the same in driving direction and in braking direction.

Further preferably, in conjunction with this, half of the mass of the workpiece support and half of the mass of the optionally provided rotary table supported by it is allocated, respectively, to each slide. Further preferably, each slide may also be allocated half the weight of an average workpiece or also half a workpiece maximum weight. Further preferably, the two linear drives display the same maximum speed and corresponding inherent dynamics.

This aids the dynamics of the total machine tool, so that—even with rapid adjustment movements—both slides will move synchronously. This is true, in particular of the position control devices of the two linear drives, wherein—in the dynamic case—temporary tracking errors, i.e., temporary control deviations, may occur. Preferably, the control deviations are such that the temporary control deviations of the two linear drives are the same.

Preferably, the first slide is set up to connect the first and the second guide arrangements, i.e., their movable parts, in an essentially torque-proof manner. In contrast, the second slide is connected to the first slide only via the workpiece support.

The workpiece support is supported by the first slide preferably via a pivot bearing whose axis of rotation (A-axis) is oriented horizontally. This pivot bearing may be, for example, a multi-row ball bearing, a multi-row roller bearing, for example a cross roller bearing, or the like. The second slide preferably also supports a pivot bearing that is arranged concentrically with respect to the same axis (A-axis), like the pivot bearing of the first slide. However, the pivot bearing of the second slide may be a radial bearing without axial support component.

Furthermore, the workpiece support may support a rotary table whose axis of rotation (B-axis) is oriented vertically in inoperative position of the workpiece support. Consequently, the workpiece is associated with two axes of rotation and one linear axis, and the working spindle is associated with two linear axes. An axis association of the tool and the workpiece different therefrom is of course possible.

Each of the two linear drives is provided with a position detecting device that, preferably, is controlled synchronously by a common control device. The liner drives may be, for example, motor-driven ball screw drives, wherein the appropriate actuating motors comprise angle transmitters. These angle transmitters may be connected to the common control. Alternatively or additionally, there may be provided linear position detecting means that detect the positions of the first and the second slides and transmit them to the control device. In this manner it is possible to ensure a synchronous movement of the two slides, even in the event of highly dynamic positioning tasks.

### BRIEF DESCRIPTION OF THE DRAWINGS

Additional details of advantageous embodiments of the invention are the subject matter of the claims or the corresponding description and the drawings. They show in

FIG. 1 a perspective overview display of a machine tool according to the invention and

FIG. 2 a symbolic plan view of a part of the kinematics of the machine tool according to FIG. 1.

### DETAILED DESCRIPTION

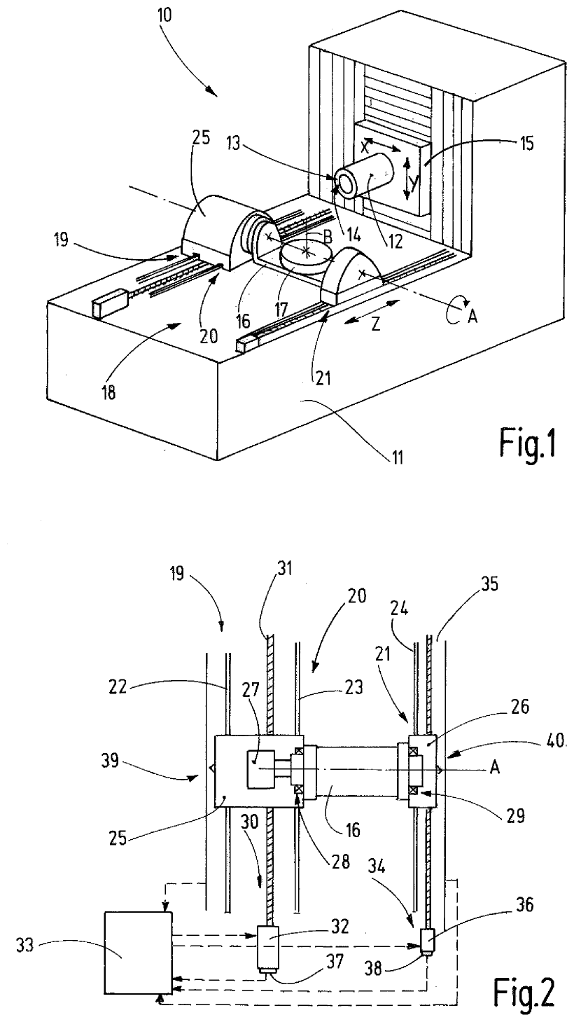

FIG. 1 shows a machine tool 10 that is set up for the 5-axis machining of workpieces. To accomplish this, the machine tool 10 comprises a base frame 11 that ultimately is disposed to receive and discharge forces acting between the machine tool and the workpiece. For machining the not illustrated workpiece, there is used a likewise not illustrated machine tool that is positioned and driven by a working spindle 12. For this, the working spindle 12 has a tool receptacle 13 that typically represents a standardized interface. Not specifically illustrated are a machine tool changing unit and a machine tool magazine as are typically used in combination with the machine tool 10.

The working spindle 12 is provided with a rotary drive device in order to drive the tool in a rotating manner about an axis of rotation 14 or also be able to hold said tool in a specified rotary position.

The working spindle 12 is supported by a slide 15 that belongs to a positioning device by means of which the working spindle 12 can be moved at least in one direction, preferably in two directions X and Y that preferably are oriented at a right angle with respect to the axis of rotation 14. For example, these are a horizontal direction X and a vertical direction Y.

For the accommodation of the workpiece there is provided a workpiece support 16 that, in a 4-axis machine, may be designed directly for the accommodation of the workpiece, and, referring to 5-axis machine depicted by FIG. 1, is provided with a rotary table 17 for the accommodation of the workpiece or a workpiece palette. In doing so, the workpiece support 16 is held so as to be pivotable about and axis A that extends transversely to the axis of rotation 14, said axis A being oriented horizontally in the preferred embodiment. For this, the axis B of the rotary table 17 is preferably oriented at a right angle, so that it is oriented vertically in zero position of the workpiece support 16.

For the support and controlled movement of the workpiece support 16, there is provided a positioning device 18 that comprises at least two—in the present exemplary embodiment three—guide devices 19, 20, 21. The guide device 19 is optional, i.e., it may also be omitted in a simplified embodiment. With the exception of this fact, the description hereinafter applies analogously to this simplified embodiment.

Respectively one guide rail 22, 23, 24 belongs to the positioning devices 19, 20 21, as is particularly obvious from FIG. 2. The first and the second guide rails 22, 23 guide a first slide 25 that is associated with the first and the second linear guides 19, 20 together and bridges the guide rail 22, 23. The third linear guide 21 comprises a second slide 26 that moves on the third guide rail 24. The guide rails 22, 23, 24 are oriented parallel to each other. Preferably, they are arranged horizontally and thus guide the two slides 25, 26 in Z-direction that is oriented preferably at a right angle with respect to the guide directions X and Y of the slide 15.

The distance between the first guide rail 22 and the second guide rail 23 is preferably less than the distance between the second guide rail 23 and the third guide rail 24. Between the second guide rail 23 and the third guide rail 24, there is preferably arranged a not specifically illustrated chips channel that is disposed to receive and remove of chips that occur in the course of chip machining the workpiece.

The first slide 25 supports the rotary device (FIG. 2) whose rotary positioner is coupled with the workpiece support 16 in a torque-proof manner. In doing so, the workpiece support 16 is held via a bearing, preferably a rolling bearing 28, so as to be held on the slide 25 movably about the horizontal axis A. Preferably, the rolling bearing 28 is configured as a combined bearing for receiving radial forces and axial forces. For example, it may be an appropriate ball bearing, roller bearing or the like. The rolling bearing 28, in particular, may be designed for torque bracing and be configured for this, e.g., as a cross roller bearing. In addition, the workpiece support 16 on the second slide 26 is held by a bearing, preferably a rolling bearing 29, so as to be rotatable about the axis A. The rolling bearing 29, in turn may be a ball bearing, a roller bearing or the like. It may be configured strictly as a radial bearing or also as a combined radial and axial bearing.

The linear guides 19, 20 are associated with a first linear drive 30 that may be configured as a spindle drive, for example. For example, the linear drive 30 is configured as a threaded spindle drive with a threaded spindle 31 that is associated with a drive motor 32. The latter rotates the threaded spindle 31 for longitudinally positioning the first slide 25 along the two guide rails 22, 23. A machine control 33 is disposed for the controlled actuation of the motor 32.

The third linear guide 21 is associated with a second linear drive 34 that also comprises a threaded spindle 35 and a drive motor 36 for driving the threaded spindle 35 in a rotating manner. The threaded spindle 35 that is arranged parallel to the threaded spindle 31 and, other than that, also parallel to the guide rails 22, 23, 24, may have the same diameter or, as preferred, also a smaller diameter than the threaded spindle 31. The drive motor of the threaded spindle 35 may display a smaller maximum torque than the drive motor 32. Preferably, the two linear drives 30, 34 are the same in view of acceleration and tracking error. To do so, the ratio of maximum drive torque of the drive motor 32 and the mass of the slide 25, as well as the components supported by it, in particular the rotary positioner 27, are essentially the same as the ratio of maximum torque of the drive motor 36 and the second slide 26. When the masses are allocated to the drives for forming the aforementioned ratios, the first slide 25 is allocated half of the mass of the workpiece support 16 and, optionally, the rotary table 17. The other half of the mass of the workpiece support 16 and, optionally, the rotary table 17 is allocated to the slide 26.

Both drive motors 32, 36 may be provided with a rotary encoder 37, 38 that is connected to the machine control 33 in order to allow a control of the rotary motion of the respective drive motor 32, 36. Furthermore, the first linear drive 30, as well as the second linear drive 34, may be provided with a linear distance measuring device 39, 40 that precisely determines the linear position of the slides 25 and 26, respectively, and delivers the measured values to the machine control 33.

The machine tool 10 described so far operates as follows:

During operation, the control device 33 controls the drive motors 32, 36 for the linear positioning of the two slide 25, 26, as well as the rotary positioner 27 in order to define the angular position of the workpiece support 16. Furthermore, the machine control 33 is provided with the rotary table 17 as well as the not specifically illustrated positioning device for the slide 15 and the rotary drive device for the machine spindle 12 in order to control all axes of the machine tool 10 consistent with the specified program. In doing so, the drive motors 32, 36 can be actuated synchronously in such a manner that both slides 25, 26 move synchronously in Z-direction and are positioned as desired. In doing so, the control is set up to avoid mutual tracking between the slides 25, 16 and thus a tilting moment load of the rolling bearing 28, 29. This applies to the acceleration and deceleration phases, as well as, in particular, in the event of a machine crash in which—as a consequence of a tool fracture, programming error or other harmful factors of influence—a collision is noted between the tool or working spindle 12 and the workpiece or workpiece support 16 or the rotary table 17. In the event of such a crash situation, particularly strong forces are introduced in particular also in Z-direction. These are transmitted by both rolling bearings 28, 29 as almost only a radial bearing load on the two slides 25, 26. This load is largely non-damaging to suitable radial bearings. The two slides 25, 26 and the connected linear drives 30, 34 receive the force essentially symmetrically and thus transmit it in a non-damaging manner to the base frame.

The machine tool according to the invention comprises a workpiece support 16 that is held so as to be pivotable about an A-axis. In doing so, the workpiece support 16 is held asymmetrically to the extent that it is connected only on one side to a rotary positioner 27. However, both sides are held on the slides 25, 26, each being connected to a linear drive 30, 34. The slide 26 without rotary drive runs only on one guide rail 24, whereas the slide 25 with the rotary positioner 27 runs on two guide rails 22, 23.

In view of the Z-acceleration, the workpiece support 16 is guided symmetrically. This means that the quotient of effective driving force and mass connected to the respective linear drive is (substantially) the same for both linear drives. The result is a compact and still highly robust machine concept.

### LIST OF SIGNS:

10 Machine tool
11 Base frame
12 Working spindle
13 Tool receptacle
14 Axis of rotation
15 Slide
16 Workpiece support
17 Rotary table
18 Positioning device
19 First linear guide
20 Second linear guide
21 Third linear guide
22 First guide rail
23 Second guide rail
24 Third guide rail
25 First slide
26 Second slide
27 Rotary positioner
28 Rolling bearing of the slide 25
29 Rolling bearing of the slide 26
30 First linear drive
31 First threaded spindle
32 Drive motor of the threaded spindle 32
33 Machine control
34 Second linear drive
35 Second threaded spindle
36 Drive motor of the threaded spindle 35
37 First rotary encoder
38 Second rotary encoder
39 Linear distance measuring device
40 Linear distance measuring device

1. A machine tool (10) for 5-axis machining, comprising:
a machine frame (11) on which are arranged a first linear guide (20) parallel to to a second linear guide (21), wherein the first linear guide (20) comprises a first guide rail (23) and a first slide (25) and the second linear guide (21) comprises a second guide rail (24) and a second slide (26) guided thereon;
first and second linear drives (30, 34) which are arranged outside of the first and second linear guides (20, 21) so that the first and second guide rails (23, 24) are arranged between the first linear drive (30) and the second linear drive (34);
a workpiece support (16) that is connected, via a first rolling bearing (28), to the first slide (25) and, via a second rolling bearing (29), to the second slide (26), wherein the second slide is separate from the first slide (25); and
a rotary positioner (27) which is arranged on or in the first slide (25) and is connected to the workpiece support (16).

2. The machine tool according to claim 1, further comprising a third linear guide (19) parallel to the first and second linear guides (20, 21), said third linear guide comprising a third guide rail (22) on which the first slide (25) is additionally guided, wherein the first linear drive (30) is arranged between one of the first or the second linear guides (20) and the third linear guide (19).

3. The machine tool according to claim 2, wherein the first slide (25) is arranged so as to bridge of the first, second, and third guide rails (22, 23).

4. The machine tool according to claim 2, that wherein the first slide is arranged so as to bridge the first linear drive (30) located between the first and third guide rails (22, 23).

5. The machine tool according to claim 2, wherein the second slide (26) is connected to the second guide rail (24) and the second linear drive (34).

6. The machine tool according to claim 1, wherein the workpiece support (16) is supported in a freely rotatable manner on the second slide (26).

7. The machine tool according to claim 1, wherein the machine frame (11) supports a guide arrangement for a working spindle (12) that is configured to accommodate a tool for machining a workpiece.

8. The machine tool according to claim 7, wherein the guide arrangement is configured to move the working spindle (12) in at least two spatial directions (x, y) relative to the workpiece support (16).

9. The machine tool according to claim 1, wherein the first and second linear drives (30, 34) have different maximum driving forces.

10. The machine tool according to claim 9, wherein a quotient of the maximum driving force of the respective first and second linear drives (30, 34) and an inert mass connected to the respective first and second slides (25, 26) is as same for both the first and second linear drives (30, 34).

11. The machine tool according to claim 2, wherein the first slide (25) connects the first and the third guide rails (19, 23, 22) to each other in a torque-proof manner.

12. The machine tool according to claim 1, wherein the first and second rolling bearings (28, 29) define an axis of rotation (A) for the workpiece support (16), said axis being oriented horizontally.

13. The machine tool according to claim 12, wherein the workpiece support (16) supports a rotary table (17) that has an axis of rotation (B), said axis being oriented at a right angle with respect to the axis of rotation (A) of the workpiece support (16).

14. The machine tool according to claim 1, wherein each of the first and second linear drives (30, 34) is provided with a position detecting arrangement (37, 38, 39, 40) and are synchronously controlled by a common control device (33).

15. The machine tool according to claim 14, wherein the position detecting arrangement (37, 38, 39, 40) comprises linear sensors for detecting a position of the first and second slides (25, 26).
